(19) United States
(12) Patent Application Publication
(10) Pub. No.: US 2026/0370634 A1
(43) Pub. Date: Nov. 19, 2026

(54) SYSTEMS AND METHODS FOR SECURING IN-TRANSMIT INFORMATION IN NETWORKED ENVIRONMENTS

(71) Applicant: MICRO FOCUS LLC, Menlo Park, CA (US)

(72) Inventors: Neeraj Kumar VIJAY, Bangalore (IN); Gnana Prakash Balagala, Bangalore (IN); Samarth Saxena, Bangalore (IN); Sangeetha Radhakrishnan, Bangalore (IN)

(21) Appl. No.: 19/675,160

(22) Filed: May 12, 2026

(30) Foreign Application Priority Data
May 13, 2025 (IN) 202541045868

(51) Int. Cl. H04L 9/40

(52) U.S. Cl. CPC H04L 63/0442; H04L 63/0815; H04L 63/0823

(57) ABSTRACT

A server configured for asymmetric cryptography can provide enhanced security to in-transmit information by using a public/private key pair. The receives a request from a client to access a resource and establishes a secure connection with the client using a public certificate. In some cases, the server may randomly generate at least one of: a private/public key pair consisting of the public key and the private key; or a unique opaque identifier. The client receives credentials of a user, encrypts the credentials using a public key from the public certificate, and communicates the encrypted credentials to the server. The server receives the encrypted credentials via the secure connection, decrypts the encrypted credentials using a private key corresponding to the public key, and authenticates the user using the decrypted credentials. Responsive to the user being authenticated using the decrypted credentials, the user is granted access to the resource.

### CROSS-REFERENCE TO RELATED APPLICATIONS

This application claims a benefit of priority under 35 U.S.C. §119(a) from Indian Patent Application No. 202541045868, filed May 13, 2025, entitled “SYSTEMS AND METHODS FOR SECURING IN-TRANSMIT INFORMATION IN NETWORKED ENVIRONMENTS,” the content of which is fully incorporated by reference herein for all purposes.

### TECHNICAL FIELD

This disclosure relates generally to secure electronic communication. In particular, this disclosure relates to securing electronically transmitted data through encryption. Even more specifically, embodiments of this disclosure relate to systems, methods, and computer program products for securing in-transmit information by way of client-side encryption in networked environments.

### BACKGROUND OF THE RELATED ART

Today, Transport Layer Security (TLS) is the standard cryptographic protocol for securing data in transit between clients (e.g., browsers) and servers (e.g., web servers). TLS is commonly used to provide end-to-end security of data sent between applications over the Internet.

Generally, a secure connection is established with a TLS handshake in which a client and a server negotiate their respective TLS versions and cipher suites, and authenticate the server by way of a digital certificate. Once the TLS handshake is complete, the client-server negotiated keys are used to encrypt and transmit data.

Users rely on this TLS-level encryption to secure their data. However, TLS is not without problems. For instance, a TLS connection cannot be established if the client and the server have mismatching TLS versions and/or if the client and the server have mismatching cipher suites.

More importantly, in some cases, a TLS connection can be compromised or “hacked.” A compromised TLS connection can occur because of, for instance, weak cipher suites, expired/untrusted certificates, theft of the private key, or even some unknown issues. An attacker only needs one entry point to intercept, read, and/or alter data being transmitted over the once secure, but now compromised TLS connection between the client and the server. This is known as the “Man-in-the-Middle” (MITM) attack.

Other consequence of a compromised TLS connection can include data theft and, using the stolen data, impersonation. For example, sensitive information, such as user personal data, credentials (e.g., username, passwords, etc.), session cookies, and so on can be stolen through a compromised TLS connection. The attacker may use the stolen information such as session cookies to impersonate services provided by the server.

Current solutions for solving TLS problems often involve disabling outdated protocols, enforcing stronger cipher suites, performing TLS hashing, etc. Techniques for disabling outdated protocols and enforcing stronger cipher suites are known to those skill in the art and thus are not further described herein.

TLS hashing is a used during the TLS handshake to reduce messages to fixed-length values, creating a transcript hash of all handshake messages for verification. The transcript hash is used in finished messages to prevent tampering. However, this hash-based solution is not effective due to its one-way property. This means that if the server needs data to decipher, it will not be possible.

In view of the foregoing, there is a need for innovations and improvements in the field of providing end-to-end security of in-transmit data in networked environments. Embodiments disclosed herein can address this need and more.

### SUMMARY OF THE DISCLOSURE

A goal of this disclosure is to enhance security for in-transmit information in networked environments. In embodiments disclosed herein, this goal can be achieved through asymmetric cryptography with a public/private key pair.

In some embodiments, a method for securing in-transmit information in a networked computing environment may include receiving (e.g., by a server computer implementing an access management system, an authentication server, a single-sing-on server, or the like) a request from a client device to access a resource in a networked computing environment and, in response to the request from the client device, establishing a secure connection with the client device using a public certificate. In some embodiments, the request from the client device may comprise a single-sign-on authentication request.

In some embodiments, the method may further comprise, responsive to the request from the client device, randomly generating at least one of: a private/public key pair consisting of the public key and the private key and a unique opaque identifier. The server-generated unique opaque identifier can provide added security and is opaque to the user/client. Alternatively, in some embodiments, the method may further comprise, responsive to the request from the client device, querying a trust store for the public key.

Once the secure connection is established, a user interface comprising a user interface element is provided to the client device. In some embodiments, the user interface comprises a login page, a landing page, a portal, a dashboard, a home page, a hypertext markup language (HTML) page, or a JavaServer® Page (JSP).

In some embodiments, the client device receives credentials of a user through the user interface element, encrypts the credentials using a public key from the public certificate so as to produce encrypted credentials, and communicates the encrypted credentials to the server computer.

In some embodiments, the method may further comprise receiving the encrypted credentials from the client device via the secure connection; decrypting the encrypted credentials using a private key corresponding to the public key so as to produce decrypted credentials. After decrypting the credentials, a unique opaque identifier is validated. Then, the user is authenticated using the decrypted credentials.

In some embodiments, this authentication can comprise querying a directory service associated with the resource using the decrypted credentials. The directory service may return a user object that matches the decrypted credentials. In turn, the user object can be used to validate the user for the request to access the resource.

In some embodiments, the method can further comprise validating a current session with the client device and communicating a token associated with the resource to the client device. Responsive to the user being authenticated using the decrypted credentials, the user is then granted access to the resource.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. The features illustrated in the drawings are not necessarily drawn to scale.

FIG. 1 is a diagrammatical representation of an enterprise computing environment in which an example of an access management system can be implemented.

FIG. 2 is a diagrammatical representation of an example of an access management system.

FIG. 3 is a diagrammatical representation of an example of a networked computing environment that includes a single sign-on server communicatively connected to a client device and a directory server.

FIG. 4 is a diagrammatical representation of an example of a networked computing environment that includes an access management system operating on a server machine, the access management system configured with asymmetric cryptography for providing enhanced security to in-transmit information according to some embodiments disclosed herein.

FIGS. 5A-5B show a sequence diagram that illustrates an example of a process for securing in-transmit information using a public/private key pair according to some embodiments disclosed herein.

FIG. 6 is a flow diagram that illustrates an example of a process for securing in-transmit information using a public/private key pair according to some embodiments disclosed herein.

FIG. 7 depicts a diagrammatic representation of a distributed network computing environment where embodiments disclosed can be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Today, organizations and enterprises alike rely on access management solutions to ensure only authorized users (or, more specifically, their “identities”) have the appropriate access to protected technology resources, applications, and data. An access management solution provides a cybersecurity framework with tools for authorizing users after identity validation and restricting permissions to prevent breaches, insider threats, and misuse. Such access management tools can include single sign-on (SSO), multi-factor authentication (MFA), and role-based access control (RBAC).

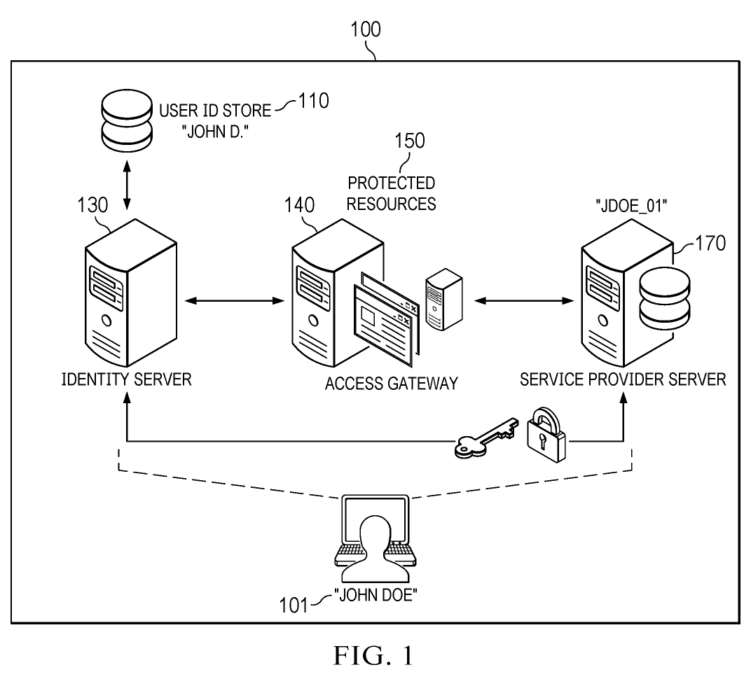

FIG. 1 is a diagrammatical representation of an enterprise computing environment 100 in which an example of an access management system is implemented. As a non-limiting example, the access management system can be part of an Identity and Access Management (IAM) system.

In the example of FIG. 1, a user 101 (“John Doe”) in the enterprise computing environment 100 wishes to use a service provided (e.g., a Software as a Service (SaaS) application) by a service provider server 170 and signs into the service using his credentials, including a username “JDoe_01.” In authenticating the credentials, the service provider server 170 verifies the identity of the user 101 with an identity server 130.

The identity server 130 maintains a user identity (ID) store 110 storing verified user identities (e.g., a user ID “JOHN D.” for the user 101) for facilitating authentication for all access management system components. Suitable authentication methods can include name/password, token-based authentication, digital certificates, time-based one-time password, etc. Additional authentication mechanisms can be readily added and implemented.

In this example, the identity server 130 is protected by an access gateway 140 which acts as a reverse proxy for the identity server 130 and enforces security policies to hide the identity server 130 from direct exposure to external systems. For example, the service provider server 170 may operate outside of the enterprise computing environment 100 and the access gateway 140 may hide the identity server 130, as well as protected resources 150, behind a firewall, with the access gateway serving as the public-facing endpoint for the enterprise computing environment 100.

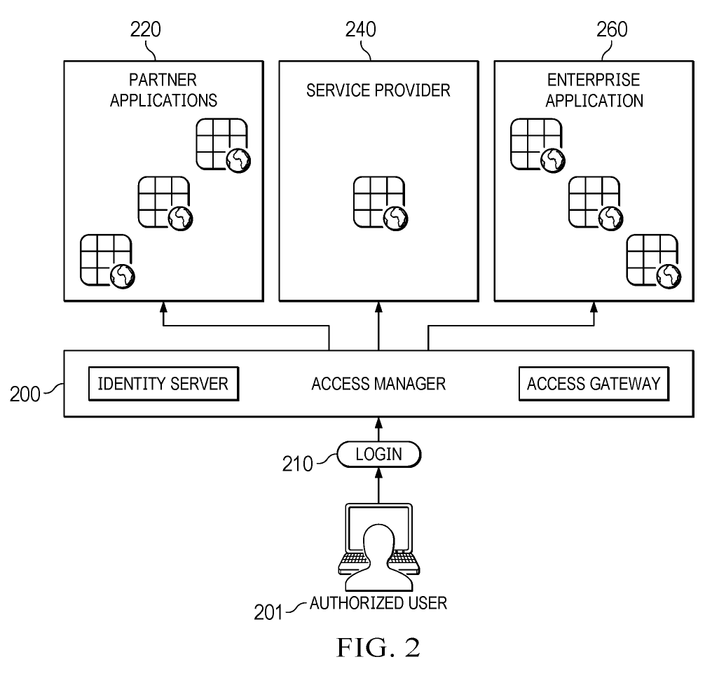

FIG. 2 is a diagrammatical representation of an example of an access management system 200 referred to as an Access Manager. In this example, the Access Manager 200 includes an identity server (which can be similar to the identity server 130 described above with reference to FIG. 1) and an access gateway (which can be similar to the access gateway 140 described above with reference to FIG. 1). As illustrated in FIG. 2, the Access Manager 200 is operable to manage traffic to partner applications 220, service provider(s) 240, and enterprise applications 260. The SaaS application described above with reference to FIG. 1 can be an example of a partner application 220 or an enterprise application 260. The service provider server 170 described above with reference to FIG. 1 can be an example of a service provider 240.

The Access Manager 200 provides a login page or portal 210 through which any authorized user 201 may, after identify validation and access permission verification, access any of the partner applications 220, the service provider(s) 240, and/or the enterprise applications 260. This is known as the SSO authentication scheme in which a single sign-on allows a user to log in once and access across multiple services, applications, and/or systems without having to reenter credentials or authentication factors.

Today, SSO systems have become an essential part of networked environments such as modern enterprise and cloud-based computing environments, allowing users to authenticate once, using a single set of credentials, and gain seamless access to a wide range of services and applications. This approach reduces the burden of managing multiple sets of credentials and improves security by centralizing authentication logic under a trusted SSO provider (e.g., an Identity Provider (IdP)).

In a typical SSO system, the user submits their credentials (e.g., username and password) to a centralized authentication authority, which verifies the identity and issues a secure token (such as a Security Assertion Markup Language (SAML) assertion, JSON Web Token (JWT), or OAuth access token). This token can then be used to access participating services without reentering credentials.

To protect user credentials during transmission, secure transport protocols such as Transport Layer Security (TLS) and Secure Sockets Layer (SSL) can be used. However, while TLS and SSL can provide some protection against eavesdropping and Man-in-the-Middle (MITM) attacks during transit, it does not completely mitigate these risks and is completely susceptible to other risks. For example, credentials may still be exposed at an endpoint (e.g., via a compromised browser or malware), or on the server side if the credentials are stored or processed insecurely. Additionally, TLS only secures data in motion — it does not secure credentials at rest or during processing within a third-party service provider such as the IdP.

Browser plug-in agents like ‘fiddler’ or ‘proxy agent’ can monitor the credentials and can potentially capture user-provided raw information. Accordingly, some authentication systems may attempt to mitigate credential exposure by capturing user-provided credentials and hashing them on the client side before transmitting them.

However, in an SSO environment, this client-side credential hashing approach introduces significant limitations. Most SSO providers (e.g., IdPs) do not have access to the user’s plaintext password, as it is either stored in a backend authentication directory (e.g., a Lightweight Directory Access Protocol (LDAP) directory or Active Directory (AD)) or managed by a federated identity system. These backend systems typically store password hashes, not the actual passwords, and rely on receiving the plaintext password for verification against their stored hash. If a client hashes a password before submission, the IdPs cannot forward the hashed password for authentication unless the exact same hash function and parameters (including salt) are used by a receiving IdP, which is rarely the case and may conflict with password policy enforcement mechanisms.

Moreover, client-side hashing does not eliminate the need for secure session management or token issuance. In most SSO implementations, the authentication result — not the password — is used to derive a time-limited, signed token that carries identity claims. The security of the underlying SSO system, therefore, hinges on both the secure handling of credentials during initial authentication and the correct issuance and validation of tokens afterward.

Because of these challenges, many SSO systems rely solely on TLS for credential protection and assume that the infrastructure is otherwise trustworthy. However, in high-security environments or zero-trust architectures, additional protection may be required. Such scenarios can include reducing credential visibility even within an SSO environment or implementing cryptographic mechanisms that limit password exposure.

Accordingly, there is a need for improved methods of credential security in networked environments that go beyond traditional transport-level protections and address the limitations of client-side hashing in access management systems, including SSO systems, where authentication must interface with secure backends that do not expose or store plaintext credentials.

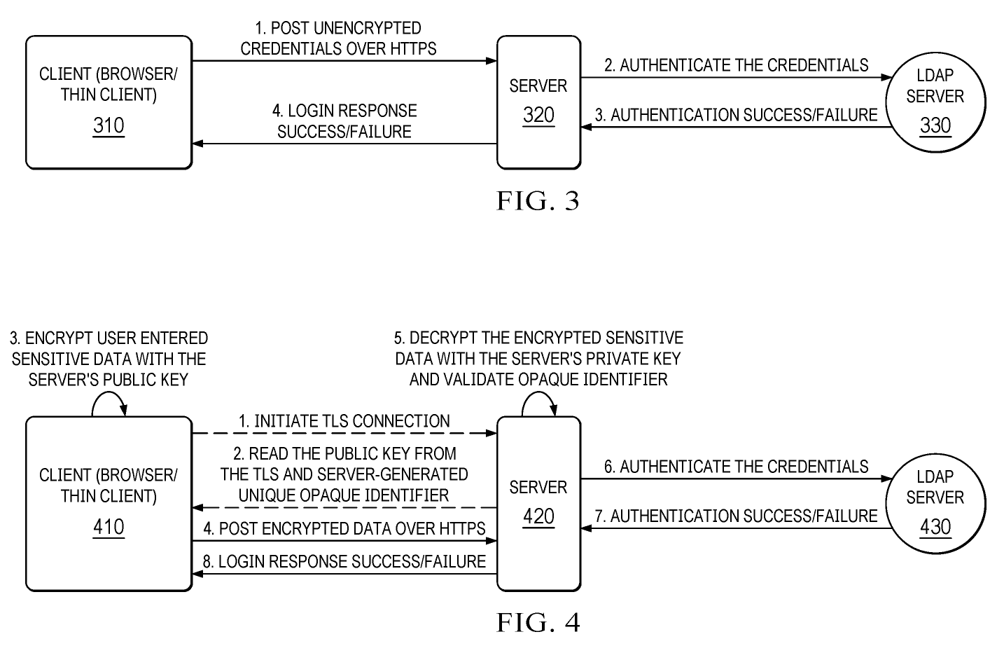

Initially, then, it may be helpful to illustrate the operation of a typical SSO environment using TLS/SSL. Referring to FIG. 3, in most cases, a user at a client device 310 may want to access some resource located on a network (e.g., a service provider, a web site, a network environment, etc.). This access may be provided through an SSO provider, for instance, through a server 320 associated with the SSO provider. As a non-limiting example, a user may attempt to access the desired location on the network and be redirected (directly or indirectly) to an authentication interface such as a web-based login page or portal (e.g., the login portal 210 described above with reference to FIG. 2). The user may provide his credentials (e.g., username and password) to the SSO server 320 through the authentication interface. The authentication interface may be provided from the desired resource, the SSO provider 320, or from somewhere else (e.g., as a thin client), and run within a browser on the client device 310.

The user-provided credentials can be communicated from the client device 310 to the SSO server 320 using Hypertext Transfer Protocol Secure (HTTPS) which uses TLS or SSL to encrypt data between the browser/thin client and the SSO server 320 (Step 1). The SSO server 320 thus received the user credentials and has access to them in the clear. The SSO server 320 can then authenticate the user credentials (Step 2) using an authentication service provider such as an LDAP server 330 (e.g., to authenticate that the user credentials are indeed associated with the desired resource). The LDAP server 330 can then return a message (e.g., “success” or “fail”) to the SSO server 320 (Step 3) in response to the request from the SSO server 320 to authenticate the user using the user credentials received from the client device 310. Based on the success or failure of the user authentication, the SSO server 320 can then notify the user at the client device 310 whether the user’s login request was successful or not (Step 4). In the case of success, the user may be provided with a token or the like and allowed to access the desired resource on the network.

As the above-described example illustrates, in this typical SSO environment, a user’s credentials may only be encrypted between a client device (e.g., the client device 310) and an authentication server (e.g., the SSO server 320) using TLS or SSL. A greater level of protection may be desired.

To that end, among others, embodiments may provide and enforce client-side encryption through asymmetric encryption with a public/private key pair. When this type of encryption is employed, two keys may be associated with an SSO server – a publicly available or distributed key (referred to as a public key) and a corresponding key known only to the SSO server (referred to as the private key). It will be understood that while the term public and private key are utilized herein to refer to the keys being utilized, these terms are utilized for ease of reference to refer to respective keys utilized in asymmetric cryptography and the “public” key employed by the client device may not be publicly distributed (e.g., in a certificate) or otherwise advertised. Further, while an SSO server is described below as a use-case example, it will be understood that the invention disclosed herein can be implemented for other types of centralized authentication systems.

In some embodiments, an SSO server is configured for supporting asymmetric cryptography. The SSO server also supports one or more of a set of certiﬁcates. For example, a digital or identity certificate is an electronic document that proves ownership of a public key. Such a “public key” certificate can act as a digital passport, binding a public key to an entity to ensure secure transmission of data to an intended recipient. The SSO server keeps their private keys and may distribute, or otherwise make available, public key certiﬁcate(s) to any client interface (e.g., thick, thin, or otherwise).

In some embodiments, a client device can obtain a public key associated with the SSO server, encrypt the user credentials (or any other data it is desired to encrypt in order to implement a higher-level security on that data), using the public key thus obtained, and transmit the encrypted credentials to the SSO server. The SSO server can decrypt the encrypted credentials thus received using a private key corresponding to the public key and provide the credentials thus decrypted to an authenticator (e.g., an authentication service provided by a service provider, which may or may not be external to the SSO server). In this manner, the credentials can be encrypted at the client device (which can be an endpoint of a “protected” network of which traffic is managed by the SSO server) to provide additional security when transmitting the credentials between the client device and the SSO server using TLS or SSL. Moreover, the SSO server may have the capability of decrypting the credential such that the user credentials can be obtained in the clear and used to validate the user, utilizing an identity or directory service such as an LDAP server.

In some embodiments, a login interface (or a component thereof) may be adapted to obtain a public key of a public/private key pair associated with the SSO server. When the user provides his credentials using the login interface, the login interface may encrypt the user-provided credentials using the public key associated with the SSO server. For example, the public key of the public/private key pair may be made available in a certificate associated with the SSO server such that the certificate may be accessed or utilized by the login interface. The encrypted credentials can then be sent to the SSO server.

In some embodiments, a user’s client device can be redirected to the SSO server when attempting to access a resource on the protected network. In response, the SSO server may provide a login interface, a landing page, a portal, a dashboard, a home page, or other types of user interface to the user’s client device. This login interface may include a component, or be adapted to access or include, a component (e.g., such as by using a <script> tag or the like), where that component can include the public key of the public/private key pair (e.g., the public key or a certificate including the public key may be embedded or otherwise included with the component).

Alternatively, the component may be adapted to access the public key (e.g., adapted to access a public key certificate or the public key at another location). This public/private key pair may have been determined in advance or be determined real-time when the login interface is provided. For example, the public key may be associated with a certificate associated with the SSO server or may be (selected from) one of a set of public/private key pairs associated with the SSO server, etc.

In other embodiments, a (e.g., random, or custom) public/private key pair may be generated at the SSO server and then communicated (e.g., embedded in, or accessible by the component) to the client device. This method has inherent security and can be useful when the client-server operate in a trusted model/relationship (e.g., when the client device and the SSO server have established a trusted connection).

The user interface (or a component thereof) provided to the client device may be adapted in such a way that it can encrypt any speciﬁc data as per application requirements and/or sensitivity of the data. In this manner, additional security may be provided with any desired data (e.g., user credentials or other data).

Thus, embodiments may provide a public key to make the client device aware of a possible operation, while adding data to the client-side login page (e.g., an HTML or JSP with JavaScript® supported, etc.). Embodiments may thus generate (e.g., custom) code for a login interface or component thereof, which will be communicated to the client device when the client device sends a request to access a particular resource location (at a universal resource locator (URL)). The provided login interface (or a component thereof) may be adapted to encrypt the user credentials (or other data) before submitting the user credentials to the SSO server. The encrypted user credentials thus adds another level of security in addition to the security implemented using TLS or SSL and hence increases the level of security of the data being transmitted.

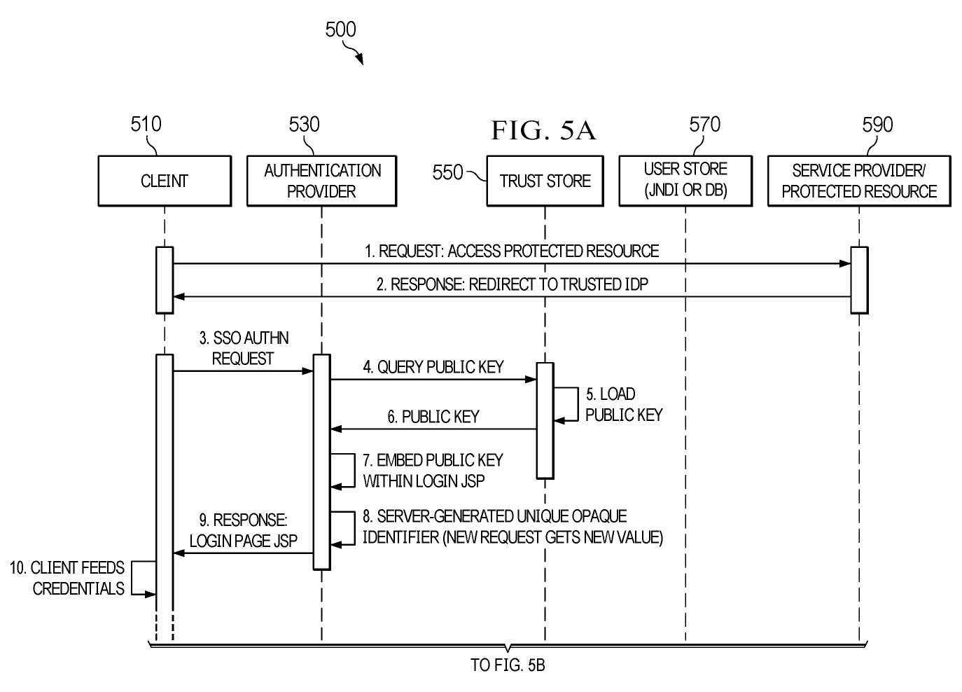

At the SSO server side, the SSO server can receive the data (e.g., the user’s credentials) encrypted with the public key and decrypt that data using a private key corresponding to the public key. The SSO server can then validate the data thus decrypted, including the user’s credentials and/or any sensitive information that was previously encrypted at and by the client device. A use-case example of this process is described below with reference to FIG. 4.

Referring to FIG. 4, a user at a client device 410 may want to access a desired resource (not shown). An access management system manages traffic to and from the desired resource (e.g., a service, a partner application, an enterprise application, a web site, a network environment, etc.). The access management system, which may implement an embodiment of an access manager or an SSO server described above, may run on a server machine 420 (which is referred to hereinafter as the server 420).

The user may direct a browser/thin client on the client device 410 to the desired resource. In response to the user’s request to access the desired resource, the browser/thin client on the client device 410 may initiate a TLS connection with the server 420 with a request for a public key (Step 1).

The server 420 is configured with a TLS/SSL certificate from a trusted Certificate Authority (CA) and implements HTTPS which uses TLS/SSL to negotiate an encrypted connection with the browser/thin client, keeping the data safe from interception. Over the encrypted connection, the browser/thin client on the client device 410 receives the TLS/SSL certificate from the server 420. Then, the server-generated public key and opaque token are sent to the client (Step 2).

As alluded to above, a login interface, landing page, or other suitable user interface with input fields, or other suitable user input elements, may be provided to the user via the browser/thin client on the client device 410. The user can enter or otherwise provide credentials and/or sensitive data to the browser/thin client on the client device 410 via these input fields. Then, the browser/thin client on the client device 410 can encrypt the user-provided credentials and/or sensitive data with the public key associated with the server 420 (Step 3).

Next, the browser/thin client on the client device 410 communicates (e.g., via an HTTPS POST request) the user-provided credentials and/or sensitive data thus encrypted with the public key associated with the server 420 to the server 420 (Step 4).

The server 420 receives the credentials and/or sensitive data encrypted with the public key associated with the server 420 and uses its private key to decrypt the credentials and/or sensitive data (Step 5). At this point, the server 420 has the credentials and/or sensitive data as provided by the user and the opaque identifier is validated.

Then, the server 420 authenticates the (unencrypted) credentials and/or sensitive data with a directory service (e.g., an LDAP server 430) associated with the desired resource (Step 6). The LDAP server 430 authenticates the credentials and/or sensitive data against the desire resource by querying a centralized, hierarchical directory database (DB) to verify the credentials and/or sensitive data.

The LDAP server 430 can then return an authentication “success” or “failure” message to the server 420 (Step 7).

Based on the success or failure of the user authentication, the server 420 can communicate to the browser/thin client on the client device 410 with a login “success” or “failure” response (Step 8). In the case of success, the browser/thin client on the client device 410 may be provided with a token or the like and allowed to proceed and access the desired resource (e.g., load a page at a network address associated with the desired resource).

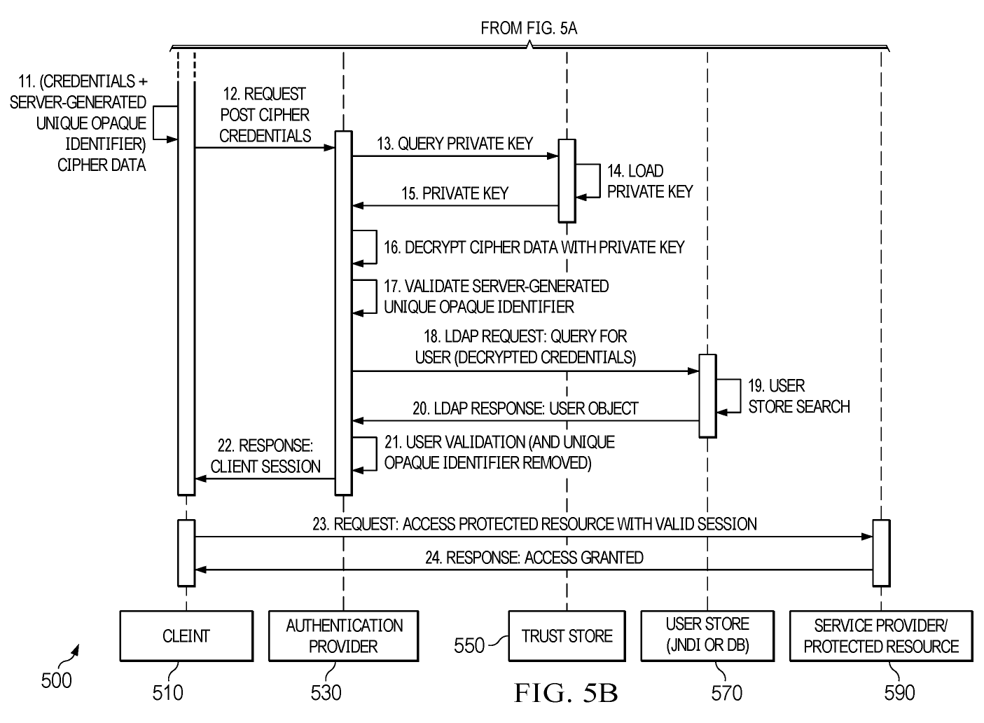

FIGS. 5A-5B show a sequence diagram that illustrates an example of a process 500 for securing in-transmit information using a public/private key pair according to some embodiments disclosed herein. In this example, a client 510 may send a request for access to a protected resource 590 (Step 1).

The protected resource 590 may be associated with and/or protected by a service provider. In response to the request for access from the client 510, the service provider/protected resource sends a response that directs the client 510 to a trusted IdP (e.g., an authentication provider 530) (Step 2). As a non-limiting example, the authentication provider 530 may implement SSO.

Based on the response from the service provider/protected resource, the client 510 sends an SSO authentication request to the authentication provider 530 (Step 3).

In response to the SSO authentication request from the client 510, the authentication provider 530 queries a trust store 550 for a public key (Step 4).

In response to the query from the authentication provider 530, the trust store 550 loads a public key (Step 5). In some embodiments, this may involve retrieving a previously generated public key of a public/private key pair. In some embodiments, this may involve randomly generate a public/private key pair in response to the query. Then, the trust store 550 sends the public key to the authentication provider 530 in response to the query from the authentication provider 530 (Step 6).

In this example, the authentication provider 530 embeds the public key within a login page (Step 7). As a non-limiting example, the login page can be implemented as a JSP.

In some embodiments, the authentication provider 530 may generate, on a per-request basis, a unique “opaque” identifier for added security (Step 8). This unique opaque identifier can be random numbers generated internally (e.g., using a randomizer). While this server-generated identifier is associated with the request, it is opaque to the user/client.

Next, the authentication provider 530 sends the login page (e.g., a JSP) embedded with the public key to the client device 510 (Step 9). The login page includes user elements (e.g., input fields) through which credentials and/or sensitive data can be entered or otherwise provided.

The client device 510 receives the credentials and/or sensitive data through the login page (Step 10).

Then, the client device 510 encrypts, using the public key, the credentials and/or sensitive data thus received through the login page (Step 11).

The client device 510 communicates (e.g., via an HTTPS POST request) the credentials and/or sensitive data thus encrypted to the authentication provider 530 (Step 12). In some embodiments, the HTTPS POST request may contain cipher data that includes a combination of the encrypted credentials and/or sensitive data and the server-generated unique opaque identifier.

In response to the HTTPS POST request containing the encrypted credentials and/or sensitive data from the client 510, the authentication provider 530 queries the trust store 550 for a private key (Step 13).

In response to the query from the authentication provider 530, the trust store 550 loads the private key (Step 14).

Then, the trust store 550 sends the private key to the authentication provider 530 in response to the query from the authentication provider 530 (Step 15).

Using the private key, the authentication provider 530 decrypts the cipher data from the client 510 (Step 16).

Next, the authentication provider 530 validates the server-generated unique opaque identifier in the cipher data (Step 17).

Then, the authentication provider 530 sends a request containing the credentials and/or sensitive data thus decrypted to a user store 570, for instance, a database (Step 18). Alternatively, the authentication provider 530 can send a request to an LDAP directory or service via a Java Naming and Directory Interface (JNDI).

JNDI is a Java® application programming interface (API) that allows applications to discover and look up data and objects via a name. JNDI can act as a common interface for interacting with various naming and directory services. JNDI is known to those skilled in the art and thus is not further described herein.

In response to the request from the authentication provider 530, the user store 570 (or an LDAP server) searches for a stored user object that matches the decrypted credentials and/or sensitive data (Step 19).

Then, the user store 570 (or the LDAP server) returns a response to the authentication provider 530 (Step 20). In this example, the response contains a user object that matches the decrypted credentials and/or sensitive data.

The authentication provider 530 receives the user object from the user store 570 (or the LDAP server) and validates the user’s request from the client device 510 to access the protected resource 590 (Step 21). At this point, the unique opaque identifier is no longer needed and, therefore, can be removed.

The authentication provider 530 then sends a response containing the user validation to the client device 510 (Step 22). The user validation is valid for the current session with the client device 510. As a non-limiting example, the response from the authentication provider 530 may contain a token for access the protected resource 590.

The client device 510 receives the user validation from the authentication provider 530 and again sends a request for access to the desired resource 590 (Step 23). This time, the request for access may contain the token associated with the desired resource 590 for the current, valid client session and, therefore, the request for access is granted (Step 24).

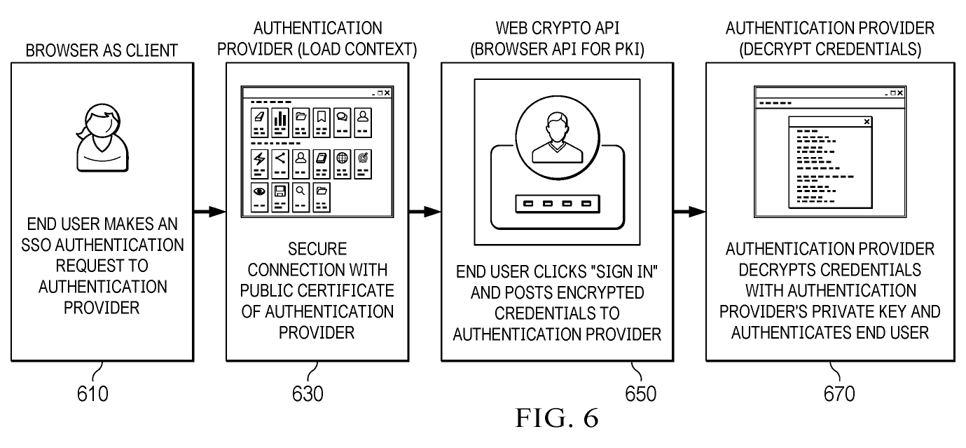

FIG. 6 is a flow diagram that illustrates an example of a process 600 for securing in-transmit information using a public/private key pair associated with an SSO server according to some embodiments disclosed herein.

In the example of FIG. 6, a browser acting as a client of an authentication provider may make an SSO authentication request on behalf of an end user to the authentication provider (610). The authentication provider secures the connection with the client using its public certificate and sends a sign-in page to the client (630). The end user provides credentials and clicks a “sign in” user interface element on the sign-in page displayed by the browser. The client receives the user-provided credentials, encrypts the credentials using the pubic key (from the public certificate), and posts or otherwise communicates the encrypted credentials to the authentication provider (650).

This operation can be done, in one embodiment, using a browser API for public key infrastructure (PKI) called Web Crypto API. The Web Crypto API allows JavaScript® to perform secure cryptographic operations such as encryption, decryption, signing, and hashing directly in web applications. The Web Crypto API is known to those skill in the art and thus is not further described herein.

The authentication provider receives the encrypted credentials from the client, decrypts the credentials using its private key, and authenticates the end user using the credentials thus decrypted (670). This operation can be similar to the authentication process described above with reference to FIGS. 5A-5B.

While some embodiments disclosed herein have been described in the context of an SSO environment, it will be apparent that these techniques may be equally effectively utilized in almost any scenario or environment where it is desired to provide additional levels of security for data to be transmitted, and in particular in any scenario where it is described to provide additional levels of security in association with browser or client based transmission of data to a server which may need to obtain that data in the clear.

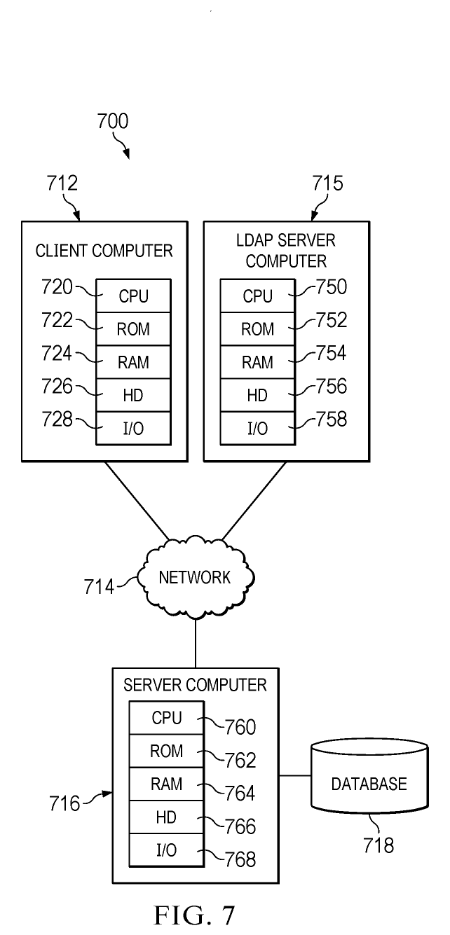

FIG. 7 depicts a diagrammatic representation of a distributed network computing environment where embodiments disclosed can be implemented. In the example illustrated, network computing environment 700 includes network 714 that can be bi-directionally coupled to client computer 712, LDAP server computer 715, and server computer 716. Server computer 716 can be bi-directionally coupled to data store 718. Network 714 may represent a combination of wired and wireless networks that network computing environment 700 may utilize for various types of network communications known to those skilled in the art.

For the purpose of illustration, a single system is shown for each of client computer 712, LDAP server computer 715, and server computer 716. However, with each of client computer 712, LDAP server computer 715, and server computer 716, a plurality of computers (not shown) may be interconnected to each other over network 714. For example, a plurality of client computers 712 and a plurality of LDAP server computers 715 may be coupled to network 714. Each of computers 712, 715 may include data processing systems for communicating with server computer 716.

Client computer 712 can include central processing unit ("CPU") 720, read-only memory ("ROM") 722, random access memory ("RAM") 724, hard drive ("HD") or storage memory 726, and input/output device(s) ("I/O") 728. I/O 729 can include a keyboard, monitor, printer, electronic pointing device (e.g., mouse, trackball, stylus, etc.), or the like. Further, client computer 712 can include a desktop computer, a laptop computer, a personal digital assistant, a cellular phone, or nearly any device capable of communicating over a network. Likewise, client computer 715 can comprise CPU 750, ROM 752, RAM 754, HD 756, and I/O 758.

Similarly, server computer 716 may include CPU 760, ROM 762, RAM 764, HD 766, and I/O 768. Server computer 716 may include one or more backend systems configured for providing a variety of services to client computers 712 over network 714. These services may utilize data stored in data store 718. Many other alternative configurations are possible and known to skilled artisans.

Each of the computers in FIG. 7 may have more than one CPU, ROM, RAM, HD, I/O, or other hardware components. For the sake of brevity, each computer is illustrated as having one of each of the hardware components, even if more than one is used. Each of computers 712, 715, and 716 is an example of a data processing system. ROM 722, 752, and 762; RAM 724, 754, and 764; HD 726, 756, and 766; and data store 718 can include media that can be read by CPU 720, 750, or 760. Therefore, these types of memories include non-transitory computer-readable storage media. These memories may be internal or external to computers 712, 715, or 716.

Portions of the methods described herein may be implemented in suitable software code that may reside within ROM 722, 752, or 762; RAM 724, 754, or 764; or HD 726, 756, or 766. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a special purpose computer or data processor that is specifically programmed, configured, or constructed to perform the functions described in detail herein.

The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips.

Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java®, JavaScript®, Python, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited to only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the disclosure should be determined by the following claims and their legal equivalents.

What is claimed is:

1. A method, comprising:
receiving, by a server computer, a request from a client device to access a resource in a networked computing environment;
in response to the request from the client device, establishing, by the server computer using a public certificate, a secure connection with the client device, the establishing comprising providing a user interface comprising a user interface element, wherein the client device receives credentials of a user through the user interface element and encrypts the credentials using a public key from the public certificate so as to produce encrypted credentials;
receiving, by the server computer, the encrypted credentials from the client device via the secure connection;
decrypting, by the server computer, the encrypted credentials using a private key corresponding to the public key so as to produce decrypted credentials; and
authenticating, by the server computer, the user using the decrypted credentials, wherein the user is granted access to the resource responsive to the user being authenticated using the decrypted credentials.

2. The method according to claim 1, further comprising:
responsive to the request from the client device, randomly generating:
a private/public key pair consisting of the public key and the private key; and
a unique opaque identifier.

3. The method according to claim 1, further comprising:
responsive to the request from the client device, querying a trust store for the public key.

4. The method according to claim 1, wherein the request from the client device comprises a single-sign-on authentication request.

5. The method according to claim 1, wherein the authenticating the user comprises querying a directory service associated with the resource using the decrypted credentials and validating a server-generated unique opaque identifier, wherein the directory service returns a user object that matches the decrypted credentials, and wherein the user object is used to validate the user for the request to access the resource.

6. The method according to claim 1, wherein the authenticating the user comprises validating a current session with the client device and communicating a token associated with the resource to the client device.

7. The method according to claim 1, wherein the user interface comprises a login page, a landing page, a portal, a dashboard, a home page, a hypertext markup language (HTML) page, or a JavaServer® Page (JSP).

8. A system, comprising:
a processor;
a non-transitory computer-readable medium; and
instructions stored on the non-transitory computer-readable medium and translatable by the processor for:
receiving a request from a client device to access a resource in a networked computing environment;
in response to the request from the client device, establishing, using a public certificate, a secure connection with the client device, the establishing comprising providing a user interface comprising a user interface element, wherein the client device receives credentials of a user through the user interface element and encrypts the credentials using a public key from the public certificate so as to produce encrypted credentials;
receiving the encrypted credentials from the client device via the secure connection;
decrypting the encrypted credentials using a private key corresponding to the public key so as to produce decrypted credentials; and
authenticating the user using the decrypted credentials, wherein the user is granted access to the resource responsive to the user being authenticated using the decrypted credentials.

9. The system of claim 8, wherein the instructions are further translatable by the processor for:
responsive to the request from the client device, randomly generating:
a private/public key pair consisting of the public key and the private key; and
a unique opaque identifier.

10. The system of claim 8, wherein the instructions are further translatable by the processor for:
responsive to the request from the client device, querying a trust store for the public key.

11. The system of claim 8, wherein the request from the client device comprises a single-sign-on authentication request.

12. The system of claim 8, wherein the authenticating the user comprises querying a directory service associated with the resource using the decrypted credentials and validating a server-generated unique opaque identifier, wherein the directory service returns a user object that matches the decrypted credentials, and wherein the user object is used to validate the user for the request to access the resource.

13. The system of claim 8, wherein the authenticating the user comprises validating a current session with the client device and communicating a token associated with the resource to the client device.

14. The system of claim 8, wherein the user interface comprises a login page, a landing page, a portal, a dashboard, a home page, a hypertext markup language (HTML) page, or a JavaServer® Page (JSP).

15. A computer program product comprising a non-transitory computer-readable medium storing instructions translatable by a processor for:
receiving a request from a client device to access a resource in a networked computing environment;
in response to the request from the client device, establishing, using a public certificate, a secure connection with the client device, the establishing comprising providing a user interface comprising a user interface element, wherein the client device receives credentials of a user through the user interface element and encrypts the credentials using a public key from the public certificate so as to produce encrypted credentials;
receiving the encrypted credentials from the client device via the secure connection;
decrypting the encrypted credentials using a private key corresponding to the public key so as to produce decrypted credentials; and
authenticating the user using the decrypted credentials, wherein the user is granted access to the resource responsive to the user being authenticated using the decrypted credentials.

16. The computer program product of claim 15, wherein the instructions are further translatable by the processor for:
responsive to the request from the client device, randomly generating:
a private/public key pair consisting of the public key and the private key; and
a unique opaque identifier.

17. The computer program product of claim 15, wherein the instructions are further translatable by the processor for:
responsive to the request from the client device, querying a trust store for the public key.

18. The computer program product of claim 15, wherein the request from the client device comprises a single-sign-on authentication request.

19. The computer program product of claim 15, wherein the authenticating the user comprises querying a directory service associated with the resource using the decrypted credentials and validating a server-generated unique opaque identifier, wherein the directory service returns a user object that matches the decrypted credentials, and wherein the user object is used to validate the user for the request to access the resource.

20. The computer program product of claim 15, wherein the authenticating the user comprises validating a current session with the client device and communicating a token associated with the resource to the client device.
